(19) United States
(12) Patent Application Publication
(10) Pub. No.: US 2011/0213717 A1
(43) Pub. Date: Sep. 1, 2011

(54) ENHANCED CUSTOMER SERVICE

(75) Inventor: Thomas Joseph Prorock, Raleigh, NC (US)

(73) Assignee: INTERNATIONAL BUSINESS MACHINES CORPORATION, Armonk, NY (US)

(21) Appl. No.: 13/103,822

(22) Filed: May 9, 2011

Related U.S. Application Data
(62) Division of application No. 10/407,558, filed on Apr. 4, 2003, now abandoned.

(51) Int. Cl. G06Q 10/00

(52) U.S. Cl. 705/304

(57) ABSTRACT

A user such as a customer or store employee uses a service finding node to generate a request for information related to a desired service. The request is made on an input device such as a touch sensitive panel. The service finding node sends the request to an information source such as a monitor program executing on a store controller. In response, the requested information is transmitted to the service finding node and is presented to the user via an output device such as a display. In one embodiment the presented information is displayed on a map and includes location, distance, and status information as well as directions to one or more customer service nodes providing the desired service. In a second embodiment, the presented information includes directions to an active, operational, and staffed checkout station.

### CROSS-REFERENCE TO RELATED APPLICATIONS

This application is a divisional application of and claims priority to U.S. patent application Ser. No. 10/407,558 entitled ENHANCED CUSTOMER SERVICE APPARATUS, METHOD, AND SYSTEM and filed on Apr. 4, 2003 for THOMAS JOSEPH PROROCK, which is incorporated herein by reference.

### FIELD

The invention relates to an enhanced customer service system. More specifically, the invention relates to requesting and providing information regarding services available within retailing establishments and the like.

### BACKGROUND

Shopping for merchandise of any type can be a time consuming and frustrating experience. Shoppers are often at a loss as to where to find the items they are searching for, resulting in the customers spending inordinate amounts of time searching, and often having to seek out store personnel for help. Nevertheless, even store personnel are often unable to stay abreast of current pricings, promotional items, inventory, and staffed locations. Shoppers wanting to do price comparisons often find themselves in the way of other shoppers. Sale items are not always known in advance, resulting in fewer return trips by shoppers searching for bargains. Furthermore, some stores, such as large department stores, may be so large so as to overwhelm the shopper.

On the other hand, advances in computing technology such as fast processing speeds and large, cheap random access memory make it possible to offer services that have not previously been feasible. An increasing number of merchants are using electronic signage that allows them to instantaneously change prices and promotional messages on in-store displays, and synchronize prices at the cash register, all through a central computer.

Driving this interest in electronic signage is the dynamic nature of the in-store environment. Human error in updating and maintaining ‘limited time only’ promotional signs often results in customer frustration and lost revenue for retailers who often feel obligated to honor markdowns no longer in effect. Controlling pricing and specials from a centralized source can help cut down on these costly mistakes.

Even with the technical advances of the computer era, shoppers are still faced with the problem of finding services they are in need of. One example may be a checkout service at a checkout counter. Unlike many stores where all of the checkout counters are located in the front of the store, service-oriented retailers often disperse their checkout counters at strategic locations throughout the store. In such cases, shoppers are often unaware of the layout of the store and can become confused about where to pay for items selected for purchase. Shoppers can also spend considerable amounts of time wandering through the store until a checkout counter is located. Even then, the checkout counter may not be operational, due to a lack of personnel at the checkout counter to assist the shopper. Thus, the shopper is left to search again for a checkout counter that is active.

Due to the voluminous nature of many retail establishments, retailers are at times forced to staff additional personnel in order to assist shoppers in a timely fashion. The additional personnel increases the overhead costs for the retailer. Retailers are also sometimes forced to install additional customer service stations in order to increase the chances for a shopper to locate a service node. The installation of additional customer service stations increases equipment costs and reduces space available for merchandise, thus decreasing the amount of inventory a store is able to display.

What is needed are systems and methods for a shopper to request information regarding the location of, directions to, distance to, services available at, and status of customer service stations or personnel within a retail establishment thus providing enhanced customer service while reducing building and personnel costs. Such a system would reduce the time customers spend searching for customer service stations or personnel and reduce the stresses and burdens associated with shopping in large retail establishments.

### BRIEF SUMMARY

The various elements of the present invention have been developed in response to the present state of the art, and in particular, in response to the problems and needs in the art that have not yet been fully solved by currently available customer service systems. Accordingly, the present invention provides a method, apparatus, and system for providing information relating to customer service. The present invention facilitates providing information to customers regarding services such as the location of, directions to, distance to, services available at, and status of, customer service nodes distributed throughout a retail establishment or the like.

As disclosed in the following description, customer service nodes are locations or personnel equipped to provide services to customers. Nodes may be mobile or stationary. Mobile nodes may be tracked by a GPS system or the like. Examples of customer service nodes include store clerks, managers, checkout personnel, return counters, pickup counters, information counters, checkout counters, layaway counter, restroom facilities, and the like. Other examples of customer service nodes include wood cutting, glass cutting, blind cutting, key duplication, and the like. Further examples of customer service nodes include photo departments, eye exam department, restaurants, snack bars, floral department, and the like. In order to provide services effectively, customer service nodes may include specialized equipment such as point-of-sale terminals and the like.

In one aspect of the present invention, a method for providing information relating to customer service includes monitoring a plurality of customer service nodes, receiving a request for information from a service finding node, and providing information pertaining to services of a customer service node to the service finding node. The information provided may, in one embodiment, be the location where the services are provided. In one embodiment, the method further includes monitoring the status of various customer service nodes and presenting service related information on a display map. In one embodiment, the service related information presented to a customer includes directions to, distance to, location of, status of, and services available at, a customer service node. The method of improving customer service facilitates proceeding directly to a customer service node that is actively providing a desired service without searching aimlessly for the service.

In another aspect of the present invention, an apparatus for providing information relating to customer service includes one or more service finding nodes, a plurality of customer service nodes, and at least one information source configured to provide information pertaining to services provided by the customer service nodes to the service finding nodes. The provided information may comprise the location at which the services are provided.

The service finding nodes interact with a user, generate information requests on behalf of the user and present service related information from fulfilled information requests to the user. Service finding nodes may reside at sales terminals, electronic kiosks, automated teller machines, or the like, as well as at locations proximate to merchandise. In one embodiment, a service finding node comprises electronic signage with touch sensitive menus that enables a user to select a desired service from a list of available services. Once selected, a request for information related to the desired service is generated, fulfilled, and presented to the user. In a further embodiment, a service finding node is configured to converse with a customer. The service finding node may converse using a microphone, speakers, a speech recognition module, a speech synthesis module, or the like. In one embodiment, the service finding node facilitates communications with a store clerk.

Various elements of the present invention are combined into a system for providing information relating to customer service. In one embodiment, the system includes one or more service finding nodes, a plurality of customer service nodes, and at least one information source configured to provide information regarding services available at one or more customer service nodes to the service finding nodes. The system further includes a store controller configured to communicate with the service finding node and the customer service nodes.

In selected embodiments, the system for providing information relating to customer service includes a store controller such as is commonly found in a back office, and which is configured to communicate with equipment such as point-of-sale terminals, service finding nodes, and the like, that may be located at the customer service nodes. In one embodiment, status information regarding each customer service node is maintained within the store controller. The status information may indicate whether a customer service node is operational, which services are currently available, the expected wait time for service, and the like.

The present invention facilitates providing information to a customer such as the location of, the services available at, the directions to, and the status of one or more customer service nodes. In one embodiment, the present invention also provides a customer with the option of sending a monitor program a request to locate the closest active customer service node and ascertain the various services currently offered at the node.

The various elements and aspects of the present invention provide information regarding services available at customer service nodes. The present invention increases customer service by eliminating unnecessary time a customer might spend searching for specific services. Furthermore, the present invention may reduce building, capital equipment, and personnel costs associated with providing prompt customer service. These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram illustrating one embodiment of a service finding system of the present invention;

FIG. 2 is a block diagram further illustrating specific elements of one embodiment of the service finding system of the present invention;

FIG. 3 is a block diagram illustrating one example of a service finding node in accordance with the present invention;

FIG. 4 is a flow chart illustrating one embodiment of a service finding method of the present invention;

FIG. 5 is a flow chart illustrating one embodiment of a customer interaction method of the present invention; and

FIG. 6 is a block diagram illustrating one example of a customer interaction interface in accordance with the present invention.

### DETAILED DESCRIPTION OF THE INVENTION

Many of the functional units described in this specification have been labeled as modules, in order to more particularly emphasize their implementation independence. For example, modules may be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. For example, a module of executable code could be a single instruction, or many instructions, and may even be distributed over several different code segments, among different programs, and across several memory devices.

Modules may also be implemented in hardware as electronic circuits comprising custom VLSI circuitry, off-the-shelf semiconductors such as logic chips, transistors, or other discrete components. A module may also be implemented in programmable hardware devices such as field programmable gate arrays, programmable array logic, programmable logic devices or the like.

Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

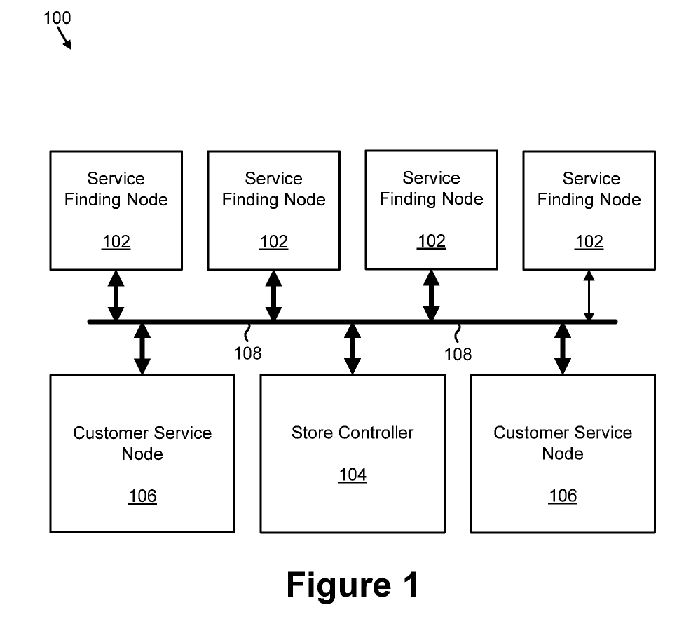

FIG. 1 is a block diagram illustrating one embodiment of a service finding system 100 of the present invention. The depicted service finding system 100 includes one or more service finding nodes 102, a store controller 104, and one or more customer service nodes 106. As depicted, the service finding nodes 102, the store controller 104, and the customer service nodes 106 are interconnected via a communications medium such as a network 108. The depicted service finding system 100 is configured to provide information to a user pertaining to one or more customer service nodes 106.

To facilitate communications, the store controller 104 and the customer service nodes 106 may be connected by the network 108. The network 108 may include one or more local area networks with wireless and/or wired segments. In one embodiment, the store controller 104 is remotely located, and the network 108 includes a wide-area network.

The depicted service finding nodes 102 are preferably configured to interact with a user. In one embodiment, the service finding node 102 includes electronic signage equipped with touch sensitive menus. In another embodiment, the service finding node 102 includes a computer terminal equipped with audio speakers and a visual display which may be touch sensitive. In one embodiment, the service finding node 102 is portable. A plurality of the service finding nodes 102 may be strategically located throughout a store or other facility for ready access by customers.

A user may interact with a service finding node 102 in order to seek information regarding one or more customer service nodes 106. The customer service nodes 106 may include personnel such as store clerks and managers and may be one or more customer service stations such as checkout counters, return counters, pickup counters, information counters, restrooms, kiosks, automated tellers, and the like. The customer service nodes 106 may further include one or more layaway counters, wood cutting departments, glass cutting stations, blind cutting stations, key duplication stations, and the like. Further examples of customer service nodes include photo departments, eye exam departments, restaurants, snack bars, floral departments, and the like.

A request to locate particular services may be sent from the service finding node 102 to an information source such as the store controller 104. Alternately, the request may be sent directly from the service finding node 102 to one or more customer service nodes 106. In the depicted embodiment, the store controller 104 maintains a record containing information regarding one or more customer service nodes 106. In a further embodiment, the store controller 104 maintains a record of status information regarding one or more customer service nodes 106. The status information may include, but is not limited to, operational, not operational, online, offline, suspended, manned, unmanned, transaction in progress, average wait time, and the like.

In one embodiment, the store controller 104 provides information regarding the customer service nodes 106 that are closest to the particular service finding node 102 from which the request was transmitted. In another embodiment, the information regarding the closest customer service nodes 106 is provided directly by the customer service nodes 106 that are closest to the particular service finding node 102 from which the request was transmitted.

The depicted store controller 104 may communicate information such as location and status information regarding one or more customer service nodes 106 that are currently providing a desired service to the service finding node 102 that sent the request. The service finding nodes 102 may then interact with the user to present the requested location and status information.

In one embodiment, the service finding node 102 presents the requested location and status information by displaying directions on a map. The directions show the route from the service finding node 102 to one or more customer service nodes 106. In another embodiment, the service finding node 102 interacts with a user using verbal communication. The verbal communication may be conducted by human or may be by automated means such as a speech recognition module and a speech synthesis module. The verbal communication may include directions to, and status of, one or more customer service nodes 106. A user may then proceed from the service finding node 102 to a preferred customer service node 106.

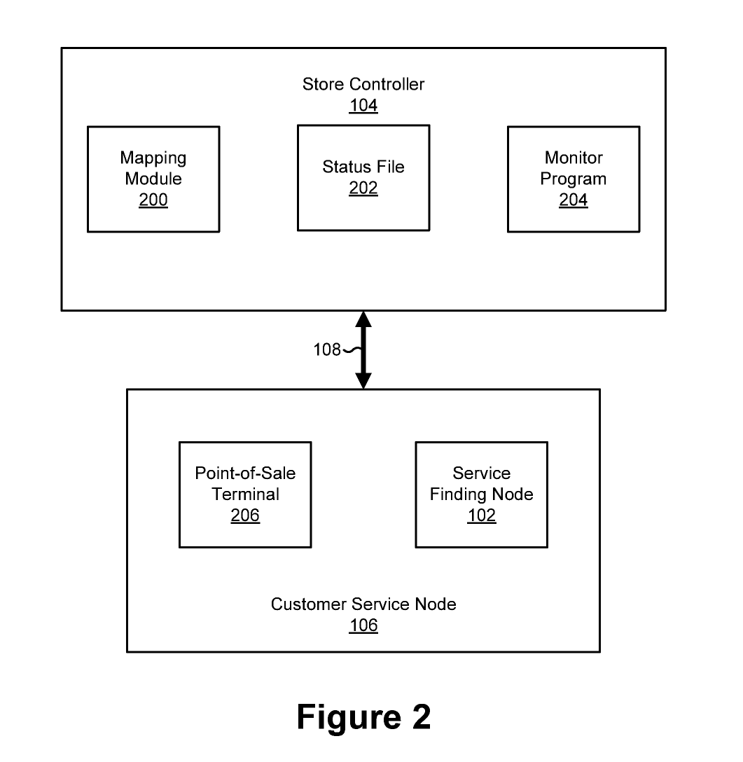

FIG. 2 is a block diagram further illustrating specific elements of the service finding system 100 depicted in FIG. 1. Specifically, one embodiment of the store controller 104 and the customer service node 106 are shown in greater detail. The service finding system 100 improves customer service by providing information to a customer pertaining to the location and status of services currently available at the customer service nodes 106.

The depicted store controller 104 is a central controller that maintains an inventory of items and prices currently available within a store. The store controller 104 may manage sales terminals and electronic signage located with the store. In the depicted embodiment, the store controller 104 includes a status file 202 and a monitor program 204.

The status file 202 includes a list of the status of, location of, directions to, and/or services available at, one or more customer service nodes 106. The monitor program 204 monitors the customer service nodes 106 and provides collected information such as status information to the status file 202. While the depicted embodiment shows the monitor program 204 residing on the store controller 104, the monitor program 204 may reside in any location or set of locations expeditious for collecting status information or the like. The status information may indicate whether a customer service node is operational, what services are currently available, the expected wait time for service, and the like.

In the depicted embodiment, the store controller 104 includes a mapping module 200. The mapping module 200 facilitates constructing a map containing information such as directions to, status of, and services available at, one or more customer service nodes 106. In one embodiment, the mapping module 200 includes a global positioning system providing the geographical coordinates to one or more customer service nodes 106.

In one embodiment, the mapping module 200 constructs a map containing directions to the closest POS terminal 206 from the service finding node 102. The response to the request is sent to the service finding node 102. The map created by the mapping module 200 and other information regarding the POS terminal 206 is displayed to the user by means of the service finding node 102.

The depicted customer service node 106 includes a point-of-sale (POS) terminal 206 and a service finding node 102. The POS terminal 206 may be a cash register that facilitates transactions between merchants and customers. In one embodiment, the POS terminal 206 is located at, but not limited to, checkout counters, pickup counters, information counters, return counters, and the like. Other examples include a layaway counter, a wood cutting department, glass cutting, blind cutting, key duplication, and the like. Further examples of customer service nodes include photo departments, eye exam department, restaurants, snack bars, floral department, and the like. The service finding node 102 interacts with a user to provide information regarding services available at various customer service nodes 106.

The service finding node 102 interacts with a user to provide information regarding one or more customer service nodes 106. The interaction may include verbal, tactile, and visual interaction. In one embodiment, the service finding node 102 is and electronic sign with touch-activated menus.

In the depicted service finding system 100, a user interacts with the service finding node 102 to request the status of, location of, and/or directions to, one or more customer service nodes 106 containing a POS terminal 206. The status of the POS terminal 206 is listed within the status file 202. The status may include, but is not limited to, active, online, offline, transaction in progress, average transaction time, suspended, and the like.

In one embodiment, the monitor program 204 receives the request provided by the service finding node 102. The request further includes an identification mark specific to the service finding node 102 that sent the request. The identification mark facilitates the response to the request to be sent to the correct service finding node 102 that originally sent the request. The monitor program 204 identifies the service finding node 102 through the identification mark and monitors the status file 202 for the current status of the POS terminal 206 closest to the service finding node 102 that sent the request.

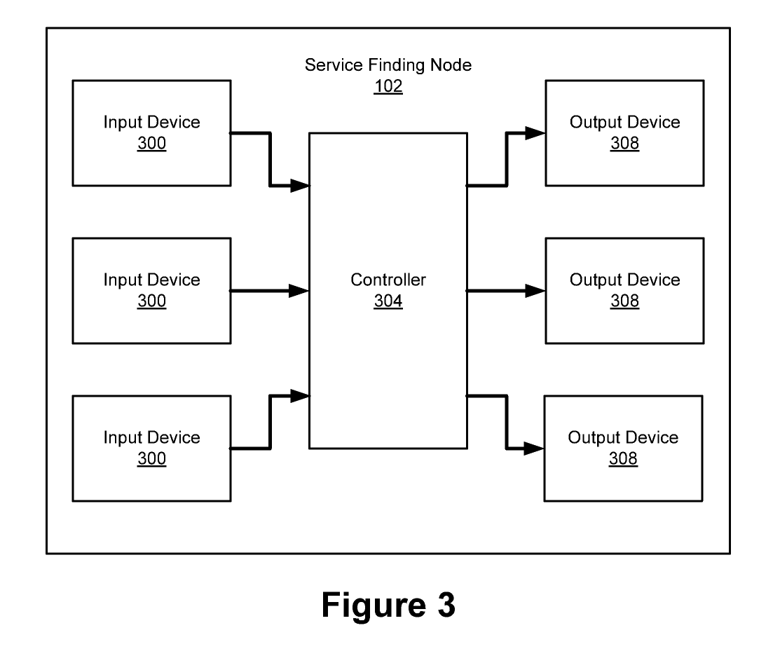

FIG. 3 is a block diagram illustrating one embodiment of the service finding node 102. As described previously, the service finding node 102 facilitates interaction with a user in order to generate requests for information to an information source and present fulfilled information requests regarding services available at one or more customer service nodes 106 to the user.

The depicted service finding node 102 includes one or more input devices 300, a controller 304, and one or more output devices 308. FIG. 3 depicts the generic nature of the service finding node 102 in that a wide variety of input devices 300 or output devices 308 may be used to provide interactive communications with a user such as a customer.

The input devices 300 provide a user with the ability to generate information requests. In one embodiment, the input devices 300 include a request information button that the user depresses to request information. In another embodiment, the input devices 300 comprise a keypad and a microphone and are configured to allow a user to generate an information request by selecting an option with the keypad or by verbalizing a request in close proximity to the microphone. In another embodiment, the input devices 300 include a touch sensitive panel. The touch sensitive panel enables a user to submit a request by touching various options displayed on the panel.

In the depicted service finding node 102, signals generated by the input devices 300 are processed by the controller 304 and are interpreted by logic resident therein to generate an information request. The information request may be sent to a centralized store controller such as the store controller 104 depicted in FIGS. 1 and 2. In selected embodiments, the controller 304 may contain memory devices for storing information related to services and providing that information directly to the user via the output devices 308.

In one embodiment, the controller 304 sends the generated request to the monitor program 204 located within the store controller 104 as described in conjunction with FIG. 2. The response to the request, which may include a map constructed by the mapping module 200, and information regarding one or more customer service nodes 106, is sent from the store controller 104 to be processed by the controller 304. In another embodiment, the service finding nodes 102 are essentially a set of input and output devices and the functionality of the controller 304 is performed by a process running on the store controller 104. In yet another embodiment, information related to currently available services is collected and cached within memory associated with the controller 304.

In the depicted embodiment, a response to an information request is processed by the controller 304 and used to generate commands to the output devices 308 in order to present the requested information. In one embodiment, the information includes a map containing the status of, location of, directions to, and/or services available at, one or more customer service nodes 106.

In one embodiment, the output devices 308 include a display monitor and an audio communication module. The display monitor allows a user to view the information such as a map containing directions to one or more customer service nodes 106. The audio communication module may include both input and output devices such as a microphone and speakers and the like. The audio communicator module facilitates providing audio information to a user regarding one or more customer service nodes 106.

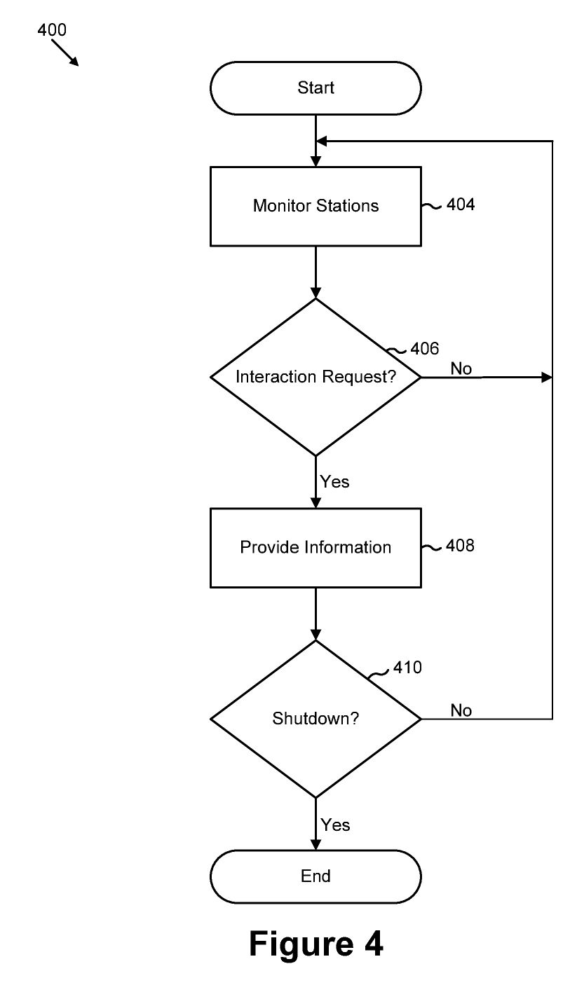

FIG. 4 is a flow chart illustrating one embodiment of a service finding method 400 of the present invention shown from the perspective of the store controller 104. The customer service method 400 may be conducted in conjunction with, or independent of, the store controller 104. The customer service method 400 facilitates fulfilling a request to provide information regarding one or more customer service nodes 106.

In the depicted embodiment, the customer service method 400 includes a monitor step 404, a request test 406, a provide step 408, and a shutdown test 410. The monitor step 404 monitors one or more customer service nodes 106. In one embodiment, the monitor step 404 monitors the status of one or more customer service nodes 106. In a second embodiment, the monitor step 404 monitors the status file 202 for updates regarding the status of one or more customer service nodes 106.

In one embodiment, the monitor step 404 is conducted by the monitor program 204 monitoring one or more customer service nodes 106. In a second embodiment, the monitor step 404 is conducted by the monitor program 204 monitoring the status file 202 for updates regarding the status of one or more customer service nodes 106.

The method 400 continues to the request test 406. If an interaction request is provided, the method proceeds to the provide step 408. Otherwise, the method 400 continues to monitor nodes at the monitor step 404 as discussed above. In one embodiment, the interaction request is a request to provide the status and location of one or more customer service nodes 106. For example, an interaction request may be a request to provide the status and locations of a customer service node 106 with an active POS terminal 206.

The method 400 proceeds to the provide step 408 which provides information regarding one or more customer service nodes 106. In one embodiment, the provide step 408 provides status information regarding one or more customer service nodes 106. In a second embodiment, the provide step 408 provides the status and location of one or more POS terminals 206. The method 400 continues to the shutdown test 410. If a component of the service finding system 100 is disabled, the customer service method 400 ends. Otherwise, the method 400 returns to the monitor step 404. In the depicted embodiment, the customer service method 400 monitors nodes, and provides information pertaining to one or more customer service nodes 106 in response to receiving an information request.

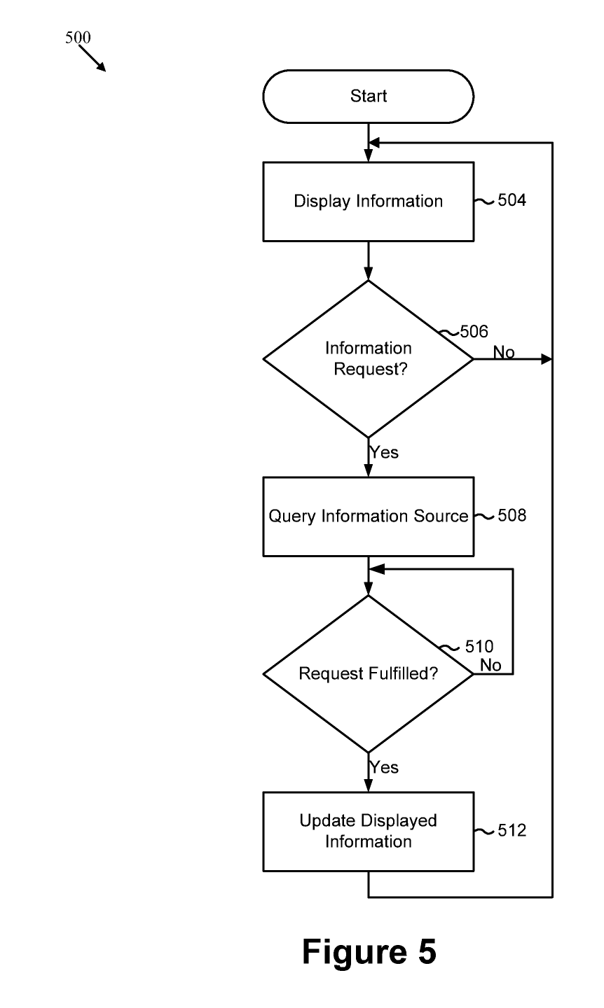

FIG. 5 is a flow chart illustrating one embodiment of a customer interaction method 500 of the present invention shown from the perspective of the service finding node 102. The method 500 may be conducted in conjunction with, or independent of, the service finding node 102. The method 500 includes a display step 504, an information request test 506, a query step 508, a request fulfilled test 510, and an update step 512. The customer service method 500 facilitates requesting and providing information regarding one or more customer service nodes 106.

The method 500 begins with the display step 504 and displays information currently known by the service finding node 102. In one embodiment, the information is displayed on one or more service finding nodes 102. The information displayed may include status and availability information pertaining to a desired service as well as directions to one or more customer service nodes 106.

The method 500 continues to the information request test 506. If an information request is provided, the method 500 proceeds to the query step 508. Otherwise, the method 500 continues to display the currently known information at the display step 504. In one embodiment, a user may generate a request for information via one or more input devices at a service finding node 102. The request submitted by the user may include a request to provide the status of, and location of, one or more customer service nodes 106 providing desired services. In a further embodiment, the request includes a request to provide the status of, location of, and directions to, the closest POS terminal 206.

Following the receipt of an information request, the method 500 proceeds to query an information source at the query step 508. In one embodiment, the information source includes the status file 202. The status file 202 provides information regarding one or more customer service nodes 106. The information provided by the status file 202 may include the status of, and/or location of, one or more customer service nodes 106 which may include one or more POS terminals 206.

In a second embodiment, the information source includes the monitor program 204, which provides information regarding one or more customer service nodes 106. The information provided by the monitor program 204 may include the status and/or location of one or more customer service nodes 106 with an active POS terminal 206.

In a third embodiment, the information source queried at the query step 508 includes one or more customer service nodes 106. The queried customer service nodes 106 may provide information regarding their own status and location as well as status information regarding equipment associated with the nodes 106 such as the POS terminals 206.

The method 500 may further facilitate locating an individual. In one embodiment, a customer service node 106 is a mobile sales associate. The information source queried at the query step 508 may include a portable device such as a PDA or cell phone. The portable device facilitates providing the location and status of a specific individual. In one embodiment, the individual is the store manager of a retail establishment or the like.

The method 500 continues to the request fulfilled test 510. If the information request as discussed above has been completed, the method 500 proceeds to the update step 512. Otherwise, the method 500 remains in a holding state until the information request has been fulfilled.

The update step 512 updates the information that is displayed. In one embodiment, the updated information is displayed by a mapping module 200 as discussed in conjunction with FIG. 2. The updated information may include a map displaying the status of, directions to, and/or services available at, the closest customer service node 106. In a second embodiment, the updated information includes audio directions to, and status of, the closest customer service node 106. In a third embodiment, the updated information includes geographical coordinates to the closest customer service node 106 provided by a mapping module 200 of FIG. 2. The updated information may then be displayed at the display step 504. The displayed information may include for example the directions to, the location of, the services available at, and the status of, one or more customer service nodes 106.

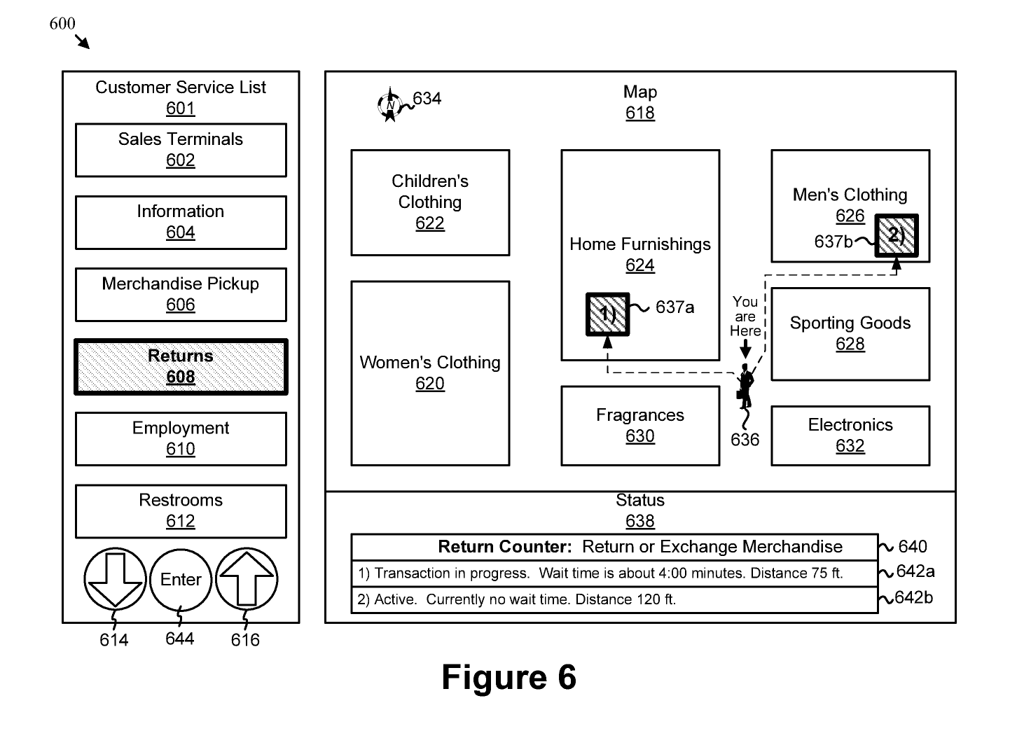

FIG. 6 is a block diagram illustrating one example of a customer interaction interface 600 in accordance with the present invention. The depicted interface 600 is one example an interface useful for conducting the customer interaction method 500 described in FIG. 5. The interface 600 may be presented by the service finding node 102 or the like.

As depicted, the service finding node 102 displays a service list 601 that displays a list of services that may be selected via service selectors 614 and 616. The service finding node 102 also displays information related to a selected service within display regions 618 and 638. The service list 601 facilitates interacting with a user to generate an information request regarding the location and availability of a desired service.

The service list 601 displays a list of services available within a store and facilitates selecting a service for which information is requested. In the depicted embodiment, the services include checkout services 602, information services 604, a pickup services 606, return services 608, employment services 610, and/or restroom services 612. The service selectors 614 and 616 facilitate scrolling up and down the service list 601 in order to select the desired service.

As depicted, a user interacts with the service finding node 102 by scrolling up and down the service list 601 and selects, by means of service selectors 614 and 616, a desired service by pressing a confirmation selector 644. For example, if a user wishes to exchange merchandise purchased at a department store, the user may select return services 608 as the service for which information is desired. After a user selects a service, a request is submitted in conjunction with the customer interaction method 500 of FIG. 5.

The depicted customer interface 600 also includes display regions 618 and 638. The display regions 618 and 638 are configured to present information to a user regarding one or more customer service nodes 106 that provide the selected service. In one embodiment, the display region 618 displays a map showing directions to and the location of customer service nodes 106 that are currently providing the selected service.

In one embodiment, the display region 638 is a status table including the status of, and services available at, one or more customer service nodes 106, and the display regions 618 and 638 present information sufficient to enable a user to locate a customer service node 106 currently providing the selected service. The information presented to a user may include the status of, location of, directions to, and/or services available at, one or more customer service nodes 106 currently providing the selected service.

In the depicted interface 600, the display region 618 displays information received from a mapping module 200 of FIG. 2. The map displayed within the display region 618 includes typical departments within a department store, such as women's clothing 620, children's clothing 622, home furnishings 624, men's clothing 626, sporting goods 628, fragrances 630, and electronics 632. The map within the depicted display region 618 also displays a compass 634 to indicate north, south, east, and west to a user, the current location 636 of the user, and the customer service nodes 637 currently providing return services 608. Using the displayed information, the user may identify and locate the service nodes 637 currently providing return services 608 and thereby proceed directly to the preferred service node without requiring human guidance.

The display region 638 may present information received from an information source such as the monitor program 204 or the status file 202 described in conjunction with FIG. 2. The depicted display region 638 includes a description 640, and status statements 642. The description 640 provides to a user information describing the selected service. The status statements 642 provide status information regarding customer service nodes 637 currently providing the selected service.

In the depicted example, the display region 638 presents a description 640 of the return services available at the selected customer service nodes 637. The status statements 642a and 642b present the current status of return counters 637a and 637b respectively, such as active, suspended, transaction in progress, and the like. Presented also within the status statements 642 may be the projected wait time at the particular return counter 637. The status statements 642a and 642b further include an identification number corresponding to the return counter 637a and 637b displayed within the map 618.

The information displayed within the map 618 enables a user to proceed from location 636 to the return counter 637a or 637b. The information provided within the display region 638 enables a user to also determine which customer service nodes 106 provide the selected service. A user may choose to proceed to the return counter 637a, given, as depicted, that return counter 637a is closest in proximity to the location 636 of the user. However, the projected wait time displayed in the status statement 642a may be longer than the projected wait time displayed in the statement 642b. Consequently, the user may choose to proceed to return counter 637b which although less proximate, has a shorter projected wait time than the return counter 637a.

The depicted customer interaction interface 600 facilitates finding a customer service node 106 that currently provides a service desired by the user. The depicted customer interaction interface 600 may be provided by a large number of service finding nodes 102, which are strategically located throughout a store to facilitate finding a desired service quickly within a large retail establishment such as a department store or the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for providing information relating to customer service, the method comprising:
monitoring a status of each of a plurality of customer service nodes, each customer service node having a fixed physical location and providing a customer with one or more services at the physical location, and about which a customer seeks information;
receiving a request from a customer, the request received at a service finding node, the service finding node mounted at a fixed location, the request comprising a request for status information pertaining to a service provided at at least one of the plurality of customer service nodes;
transmitting the request from the service finding node;
receiving, at the service finding node, status information in response to the request, the status information comprising status of a service provided at a customer service node of the plurality of customer service nodes; and
providing the received status information to the customer, the service finding node providing the received status information to the customer.

2. The method of claim 1, wherein the received status information provided to the customer comprises an indication of availability of the customer service node to provide the service to the customer.

3. The method of claim 2, wherein the customer service node comprises a point of sale (“POS”) station and wherein the indication of availability comprises an indication that the POS station is available for checkout.

4. The method of claim 1, wherein providing the received status information comprises displaying a map directing the customer to the customer service node.

5. The method of claim 1, wherein providing the received status information comprises presenting the status information audibly.

6. The method of claim 1, wherein providing the received status information comprises presenting the status information in a text format.

7. The method of claim 1, wherein monitoring a status of each of a plurality of customer service nodes is by way of a store controller in communication with the service finding node and the plurality of customer service nodes.

8. The method of claim 1, wherein the service finding node communicates wirelessly with one or more of a store controller and a customer service node.

9. The method of claim 1, wherein the service finding node is located remote from the one or more customer service nodes corresponding to the status information received at the service finding node.

10. The method of claim 1, wherein the service finding node and the plurality of customer service nodes are associated with a retail store.

11. The method of claim 1, wherein the service finding node comprises an electronic display.

12. The method of claim 1, wherein the request for status information is accompanied by an identification mark and further comprising utilizing the identification mark to determine which of a plurality of service finding nodes to provide the status information to.

13. An apparatus for providing information relating to customer service, the apparatus comprising:
means for monitoring a status of each of a plurality of customer service nodes, each customer service node having a fixed physical location and providing a customer with one or more services at the physical location, and about which a customer seeks information;
means for receiving a request from a customer, the request received at a service finding node, the service finding node mounted at a fixed location, the request comprising a request for status information pertaining to a service provided at at least one of the plurality of customer service nodes;
means for transmitting the request from the service finding node;
means for receiving, at the service finding node, status information in response to the request, the status information comprising status of a service provided at a customer service node of the plurality of customer service nodes; and
means for providing the received status information to the customer by way of the service finding node.

14. The apparatus of claim 13, wherein the means for presenting the received status information to the customer comprises displaying a map to the customer.

15. The apparatus of claim 13, wherein the means for presenting the received status information to the customer comprises providing audible status information to the customer.

16. The apparatus of claim 13, wherein the means for presenting the received status information to the customer comprises providing status information to the customer in text form.

17. The apparatus of claim 13, wherein the means for monitoring a status of each of the plurality of customer service nodes comprises using a monitor program.

18. The apparatus of claim 13, wherein the means for transmitting the request from the service finding node and means for receiving, at the service finding node, status information comprises a computer network.

19. The apparatus of claim 13, wherein the means for providing the received status information to the customer by way of the service finding node comprises an electronic display.

20. The apparatus of claim 13, wherein the means for receiving a request from a customer comprises an input device.
